(19) United States
(12) Patent Application Publication
(10) Pub. No.: US 2008/0247649 A1
(43) Pub. Date: Oct. 9, 2008

(54) Methods For Silhouette Extraction

(76) Inventor: Chun Hing Cheng, Calgary (CA)

Correspondence Address: BARNES & THORNBURG LLP, 11 SOUTH MERIDIAN, INDIANAPOLIS, IN, 46204, US

(21) Appl. No.: 10/575,308

(22) PCT Filed: Jul. 7, 2005
(86) PCT No.: PCT/CA05/01059

§ 371 Date: Apr. 11, 2006

(51) Int. Cl. G06K 9/46

(52) U.S. Cl. 382/190

(57) ABSTRACT

Methods are provided for determining the silhouette of an object in an image against a fairly plain background. The method performs initial processing to create small regions of pixels in the image that have the same grey level value. Modifying the grey level values in these regions by setting the grey level value equal to the number of pixels in the region and then performing a threshold operation aids in defining a coarse boundary of the object. Analyzing grey level values of pixels in the image external to the object defines the coarse boundary. Analyzing grey level values of pixels in the image internal to the object defines the silhouette. Additional processing steps in the method help to further define the silhouette. Steps of the method can be repeated to further refine the shape of the silhouette. The invention does not require the detection of edges, in fact it is considered to be independent of the original grey level values of pixels in the image being processed. Consequently, the invention is immune to the grey level values or textures of the object for which the silhouette is being determined or the background, and also immune to the camera and lighting setups. It works well for determining the silhouette even when the grey level value at an edge of the object is very close to that of the background.

### FIELD OF THE INVENTION

The invention relates to image processing, in particular methods of extracting a silhouette from an image.

### BACKGROUND OF THE INVENTION

In image processing, edge detection is the usual technique in finding silhouettes in monochrome images. An edge is defined as a location in an image with high grey-level contrasts, i.e. there is a large jump in grey level from one pixel to the next. There are a number of standard algorithms for detecting edges based on, for example the Sobel and Laplace methods.

In edge detection, a threshold is set for a grey-level contrast, so that an edge is formed when the contrast is above that threshold. For the silhouette extraction problem it is very difficult to provide a threshold that is consistent for all situations. If the threshold value is too low, then edges will be indicated everywhere in the image, both inside the object for which the silhouette is being determined and in the background. In this case it will be difficult to extract the silhouette from the myriad of edges.

If the threshold value is too high, then the edge may not be indicated along those parts of the silhouette where the difference in grey level between the edge of the object for which the silhouette is being determined and the background is small. For example in the case of a head-and-upper torso portrait of a person, this may occur when the grey level of hair, skin or clothing is nearly the same as that of the background. Without clearly defining the object edges, the silhouette of the object cannot be found.

As such existing methods rely on the grey levels and textures of the object and the background, as well as the lighting conditions at the time the image is captured and the exposure setting and other characteristics of the camera capturing the image. In order for these edge detection methods to succeed, the colour of the background must be carefully chosen and a sophisticated camera and lighting setup is required. This can be inconvenient, especially when a system used for imaging head-and-upper torso portraits is imaging many people with different hair colour, clothing and complexions.

### SUMMARY OF THE INVENTION

In comparison with the described edge detection methods above, the invention does not require the detection of edges; actually it makes no use of the contrast in grey level values in the image or picture being processed. Consequently, the invention is immune to the grey level values or textures of the object for which the silhouette is being determined or the background, and also immune to the camera and lighting setups. It works well even when the grey level value at an edge of the object is very close to that of the background.

According to a first broad aspect of the invention, there is provided a method comprising: extracting the silhouette of an object against a fairly plain background in an image comprising a plurality of pixels by processing the image, the processing comprising determining if adjacent pixels of the image have an equal grey level value and the processing is independent of the numerical values of the original grey level values of pixels of the image.

According to a second broad aspect of the invention, there is provided a computer readable medium having computer readable program code means embodied therein for extracting a silhouette against a fairly plain background from an image comprising a plurality of pixels, the computer readable code means comprising: code means for processing the image, the processing comprising determining if adjacent pixels of the image have an equal grey level value and the processing is independent of the numerical values of the original grey level values of pixels of the image.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Preferred embodiments of the invention will now be described with reference to the attached drawings in which:

FIG. 1 is a flow chart of a method for extracting a silhouette according to an embodiment of the invention;

FIG. 2A is an example grey scale image;

FIG. 2B is the example grey scale image of FIG. 2a in which the grey levels of the pixels are transformed by an averaging operation;

FIG. 2C is the grey scale image of FIG. 2B in which iso-grey area (IGA) regions are determined according to an embodiment of the invention and are marked with a dark border;

FIG. 2D is a grey scale image in which the grey levels of the pixels in an IGA region are equal to the number of pixels in the respective IGA region;

FIG. 3A is an example image for which a silhouette is to be extracted;

FIG. 3B is the image of FIG. 3A after initial processing of the image with the averaging operation;

FIG. 4 is the image of FIG. 3B that has been processed to be an IGA image;

FIG. 5 is the image of FIG. 4 that has been processed by analyzing the area outside the region currently determined to be silhouette;

FIG. 6 is the image of FIG. 5 that has been processed by a dilation operation;

FIG. 7 is an enlarged scale version of the image of FIG. 6 that has been processed by analyzing the area inside the region currently determined to be silhouette;

FIG. 8 is the image of FIG. 3A with the extracted silhouette superimposed on it; and

FIGS. 9A, 9B and 9C are extracted silhouettes of an object in an image where the silhouettes are superimposed over the image after a first pass of the method (FIG. 9A) and repetitions of the method to tighten the silhouette (FIGS. 9B and 9C);

### DETAILED DESCRIPTION OF THE PREFERRED EMBODIMENTS

The embodiments of the present invention disclosed herein provide an alternative to using conventional edge detection techniques for extracting a silhouette of an object with simple boundary from an image. Methods of the invention can be used for extracting the silhouette from an image of the object against a fairly plain background by a single monochrome camera. An example of the object is a head and upper body portion of a person in a head-and-upper torso portrait, such as the type taken for a passport photo or a driver's licence. A silhouette is an outline of the object in an image. In the example above the silhouette is the curve that separates the head-and-upper torso portrait of a person including hair, face, ears, neck and upper body from the background, where the hair, the face, and the upper body are within the boundary of the silhouette. More generally, the image may include any type of object with simple boundary in the image for which the silhouette is to be extracted. A “fairly plain background” is meant to define that the background does not contain any additional objects or people and does not have any distinctive visual patterns, such as lines. A plain wall or backdrop of any color lit by ambient light will satisfy the definition of a “fairly plain background”, even if brightness in the image is not uniform due to uneven lighting. In a case of a portrait of a person where the person is standing in close proximity to a wall, a well-defined shadow of the person's head being cast on the wall by a spot light may produce a distinctive visual pattern in the image that would affect the ability of the method to properly obtain the accurate silhouette of the person.

In some embodiments of the invention the method is expressed as computer implemented program code that is stored on a computer readable medium. The computer implemented program code can be run from the computer readable medium by a processing engine adapted to run such computer implemented program code. Examples of types of computer readable media are portable computer readable media such as 3.5″ floppy disks, compact disc ROM media, or a more fixed location computer readable media such as a hard disk media storage unit in a desktop computer, laptop computer or central server providing memory storage or a workstation.

An image or picture for which embodiments of the invention will operate on is stored in a digital format on a computer readable memory. The image may originate as a digital image from a digital camera or an analog image that has been digitized, for example a photo scanned by a scanner and stored in a computer readable memory.

A camera that captures a monochrome image is capable of producing a single picture in multiple grey levels. A camera that captures a colour image can be used to provide images which can be used with embodiments of the invention by first converting the colour image into a monochrome image by averaging the red, green and blue components of the pixels of the image. Generally, the monochrome picture is considered to be a rectangular array of pixels, where each pixel has an associated grey level.

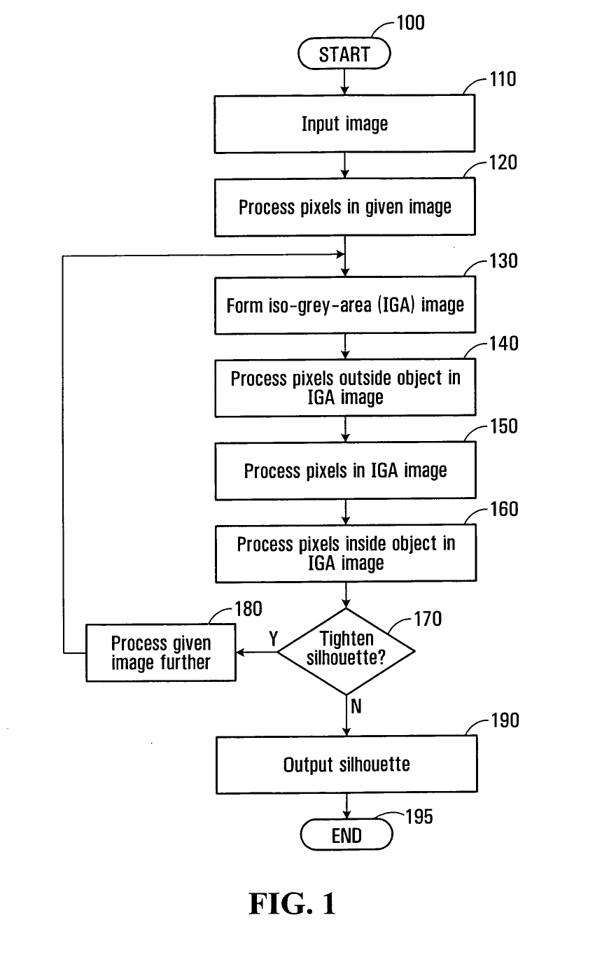

A method according to an embodiment of the invention will now be described with respect to the flow chart of FIG. 1. The method starts at step 100. At step 110, the image obtained from a source such as the camera described above is input for silhouette detection. Attributes of the image that are provided are the number of rows and columns in the image, the number of grey levels in the image, and the grey level of each pixel in the image. At step 120, the grey levels of the pixels are initially processed with the purpose of creating numerous small iso-grey area (IGA) regions along the edge of the silhouette so that the silhouette becomes more prominent. At step 130, the IGA regions are further defined in the image, for example by modifying the actual grey level of the image in each respective IGA region to be a grey level equal to the number of pixels in that respective IGA region. In step 140, the area of the image outside the object associated with the silhouette that is being extracted, is processed. At step 150, additional processing is performed to improve the boundary of the silhouette with respect to the background. At step 160, the area of the image inside the object associated with the silhouette that is being extracted, is processed. At step 170, a decision is to be made whether to further refine or “tighten” the silhouette shape. If it is decided that the silhouette is to be refined, then the “yes” path is followed and the image is further processed starting at step 180 and then repeating steps 130-170. If it is decided that the silhouette is not to be refined, then the “no” path is followed and the silhouette is output at step 190. The method ends at step 195.

Not all steps in the method of FIG. 1 are necessary to extract the silhouette. In some embodiments of the invention some of the processing steps or refining steps may not be performed if a less precise silhouette is suitable for a user's needs.

The steps of the method will now be described in more detail.

### Process Pixels in Image

At step 120, the grey levels of the pixels are modified with the purpose of creating numerous small iso-grey area (IGA) regions along the edge of the silhouette so that the silhouette becomes more prominent. IGA regions are groups of connected pixels having the same grey level value. There are a number of ways to operate on the pixels, for example using statistical, convolution and/or morphology techniques. Two particularly effective operations used in embodiments of the invention are calculating an average grey level for each pixel based on a group of pixels in close proximity to the respective pixel and calculating a median grey level for each pixel based on a group of pixels in close proximity to the respective pixel.

In determining the average grey level of a group of pixels, for each pixel in the image, the average (that is arithmetic mean) grey level of 9 pixels in a 3×3 square around a respective pixel is determined. This determined average grey level value is selected as the new grey level of that pixel. Since grey levels are integers, the average is rounded to the nearest integer value.

In determining the median grey level of a group of pixels, for each pixel in the picture, the median grey level of the 9 pixels in the 3×3 square around a respective pixel is determined and used as the new grey level of that pixel.

Determining the average and/or median grey level is performed based on the original pixel values of the image and not based on the new pixel values determined by the average and/or median calculation.

Pixels along the edges of the image will have fewer pixels around them than make up a complete 3×3 square, but methods for finding the average and the median are similar to pixels with a group of 3×3 pixels around them.

More generally, the number of pixels used in calculating the average or median may be greater than or less than the 3×3 block example described above.

Mathematical operations used in embodiments of the invention that have been found to be preferable for processing the pixels of the image are 1) “Average” only, 2) “Median then Average”, and 3) “Average then Median then Average”. However, alternative forms of these or other mathematical operations that provide appropriate processing are to be considered within the scope of the invention.

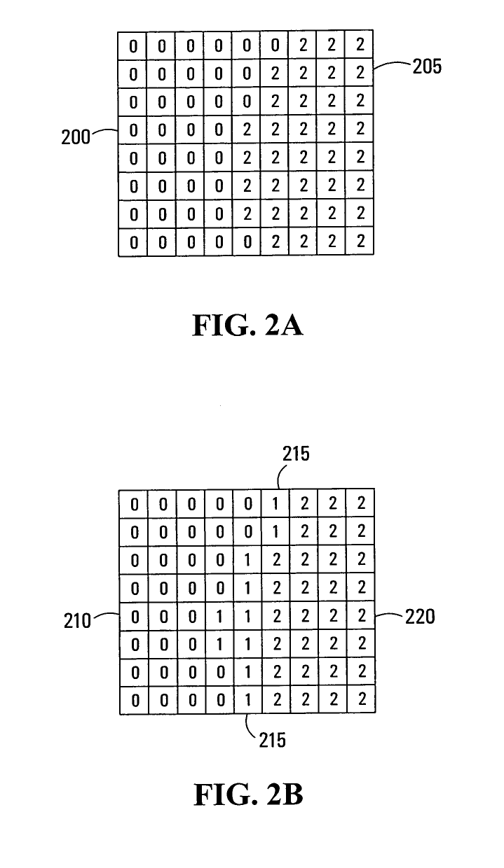

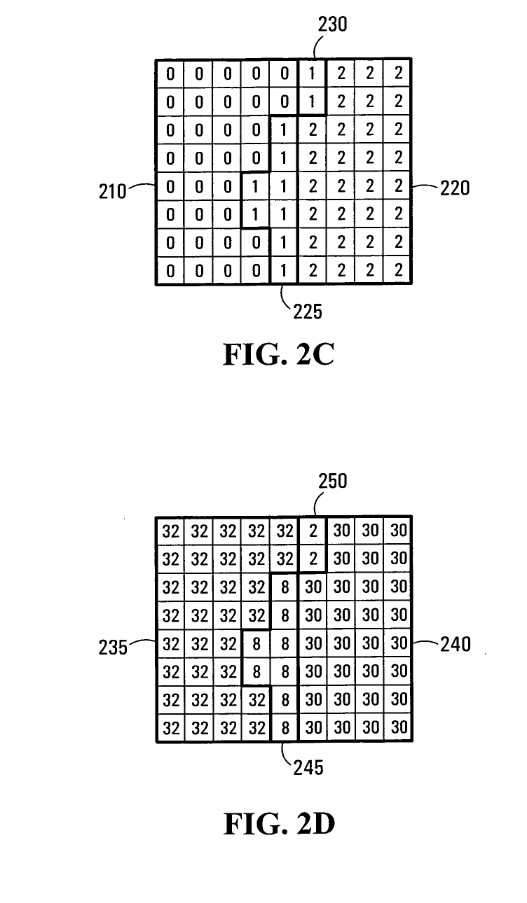

FIGS. 2A and 2B will now be described in order to understand how step 110 initially aids in creating small IGA regions. FIG. 2A is an example image containing an array of pixels where each pixel of the image is represented by a square block and the grey level for each block is shown as a number inside each block. In FIG. 2A, pixels generally indicated at 200 have a grey level equal to “0” (black) on one side and pixels generally indicated at 205 have a grey level equal to “2” (nearly black) on the other. You may think of a nearly black object against a black background. FIG. 2B is obtained after the “Average” operation described above is performed on the pixels of the image. The grey levels of some pixels, generally indicated at 215 are transformed to be equal to a grey level of “1” along the boundary between a region having pixels with a grey level equal to “0”, generally indicated at 210 and a region having pixels with a grey level equal to “2”. These pixels will form small IGA regions along the silhouette, as described in more detail below.

One may consider that if the grey levels of the object and the background differ by only a grey level equal to 1 instead of 2, then the above effect will not occur. Strictly speaking, this is true, but the chance of such a case is small. Furthermore, to handle such a case, in some embodiments of the invention the grey levels of all pixels in the image are multiplied by 2 before doing the “Average” operation.

### Form IGA Picture

At step 130, the IGA regions are formed in the image that has been altered by the “Average” and/or “Median” operations described above, and denoted as picture P from hereon. Step 130 generates an IGA picture Q from picture P, so that in future steps the silhouette is extracted from picture Q, and not from picture P.

The IGA picture Q has the same size, that is the same numbers of rows and columns, as picture P. Preferably picture Q is also monochrome with usually, but not necessarily, the same grey level granularity as picture P.

Picture P is first partitioned into mutually disjoint “4-connected” regions such that the pixels in each region have equal grey levels. These regions in picture P are called iso-grey regions. A subset of pixels is said to be “4-connected” if any two pixels in the subset are connected by a path that may or may not include other pixels in the subset, such that adjacent pixels with an equal grey level along the path are on the left/right of or above/below each other. In other words, if a pixel is considered a square, a pixel in a “4-connected” subset can only be connected to pixels on one of the four sides of the square. Regions that are “8-connected” allow for diagonal adjacency, as an “8-connected” region includes corner pixels of a 3×3 block of pixels around a given pixel, in addition to the 4 pixels, one on each side, surrounding the given pixel.

There are many ways of partitioning picture P into iso-grey regions. In some embodiments of the invention one method used is called “flooding”. Essentially, it starts with a pixel in an iso-grey region that has not yet been modified to be an iso-grey region and “floods” the neighbouring unmodified pixels that have the same grey level. This same process is repeated recursively for the flooded pixels. The area is augmented each time a pixel is flooded. To cut the overhead cost in recursion and to prevent possible stack overflow, a queue data-structure is used to perform the flooding operation. In some embodiments of the invention, a “breadth-first search” technique is used. Each unmodified pixel is loaded into the queue, and the following steps are repeated until the queue becomes empty: pop the head of the queue, mark it as modified, augment the count, and push those neighbours of the pixel at the head of the queue with the same grey level as the pixel at the head of the queue to the tail of the queue.

The number of pixels in each iso-grey region of picture P are counted. The resulting number of pixels in each region is called the “area” of that region and the region is called an IGA region.

The IGA picture Q is formed by equating the grey level of each pixel in picture Q to the IGA value of the corresponding pixel in picture P.

Referring to FIG. 2C, the image represents the processed picture P of FIG. 2B, with 4 distinct iso-grey regions identified by bold lined boundaries where the grey level equal to “0” region is indicated by 210 as in FIG. 2B, the grey level equal to “2” region is indicated by 220 as in FIG. 2B and the grey level equal to “1” regions are indicated by two separate regions 225 and 230 instead of only 215 in FIG. 2B. FIG. 2D represents the IGA picture Q whose grey levels are the corresponding IGA values. A first “4-connected” region indicated at 235, has a grey level set to 32 as 32 pixels each have the same grey level as shown in 210 of FIG. 2C. A second “4-connected” region indicated at 240 has a grey level set to 30 as 30 pixels each have the same grey level as shown in 220 of FIG. 2C. A third “4-connected” region indicated at 245 has a grey level set to 8 as 8 pixels each have the same grey level as shown in 225 of FIG. 2C. A fourth “4-connected” region indicated at 250 has a grey level set to 2 as 2 pixels each have the same grey level as shown in 230 of FIG. 2C. It is noted that the third and fourth regions have the same grey level but are not “4-connected” in the manner described above. Therefore, the regions are different IGA regions. Based on the manner in which picture Q is created this further emphasizes that the method is not dependent on the grey level of the image in determining the silhouette.

As described above, in FIG. 2D the IGA values are used directly as grey level values in picture Q. However, usually the IGA values are transformed without interest in regions in picture Q that have very large IGA values. Therefore, a user-selectable area threshold is introduced, which usually corresponds to the sizes of iso-grey regions in the background of picture P.

In some embodiments of the invention, all pixels in picture Q whose IGA value is greater than or equal to this threshold are assigned a grey level of “white”, and all other pixels in picture Q will be given a proportionate grey level between black and light grey, for example ⅞ of the total grey level range. For 256 grey levels, this ⅞ portion would be from grey level 0, “black”, to grey level 224. Using light grey instead of white as the lower bound for pixels with IGA values smaller than the threshold may help in identifying the background from the object.

For example, suppose that the original picture P has 256 grey levels and it is desirable to maintain 256 grey levels for picture Q. Setting the area threshold to 100, any pixel in picture Q with an IGA value of 100 or above will be given a grey level of 255 (white). Any pixel in picture Q in a given region with an IGA value of less than the threshold of 100 will be assigned a grey level between 0 and 224 that is proportional to the value between 0 and the threshold value of 100. In this specific example, this is a grey level equal to 32+a*192/100, rounded to the nearest integer, where “a” is the number of pixels of the given region. More generally, any threshold value can be used in place of the value of 100 used in the example above.

Note that after the IGA picture Q is obtained from picture P, picture P is no longer used. All future processing is based on picture Q and not on picture P. The method only checks whether adjacent pixels in picture P have the same or different grey levels, and uses this information to create the IGA picture and find the silhouette. The actual numeric grey level values of the pixels in P are not used beyond this point in determining the silhouette. Therefore, the method is immune to brightness of the object, ambient lighting when the image is captured, setting of the camera used to capture the image and many other image dependent characteristics.

### Process Pixels External to Silhouette Object in Picture

In step 140, the area of picture Q outside the object having the silhouette that is to be extracted, is processed. The silhouette is more apparent in the IGA picture than in the original picture. In order to extract the silhouette from the IGA picture, the image is analyzed using a disc shaped collision detector to define a coarse boundary around the object by analyzing the area outside the object and marking the coarse boundary. The disc shaped collision detector is moved around within an area of the image outside of the object of which the silhouette is to be determined to determine pixels that are not a part of the background.

In some embodiments of the invention, the collision detector is a circular disc whose radius is not too large to get trapped in the background, and not too small so that detector enters into the interior of the object of which the silhouette is to be determined. In some embodiments of the invention the radius of the detector is mainly dictated by the degree of uniformity in the grey level of the background. In a particular embodiment, a detector disc radius of approximately 6.5 times the pixel-width is an appropriate size to avoid the problems identified above.

It is to be understood that the disc shaped collision detector is one example of a detector that is moved around the image external to the object. Other shapes for the detector may be utilized, such as a square for instance.

The following is an example of how the disc shaped collision detector is used to process the area outside the object. The detector is initially positioned on the IGA picture so that its centre is at a “white” pixel somewhere near a top edge of the picture close to the top left corner. It is then advanced to the pixel below it. The detector moves in all directions (except where it came from) over the course of processing making sure that its edge does not hit any non-“white” pixel or a pixel that has already been visited. Each pixel that is encountered by the detector as it moves around the picture is identified in some appropriate manner as having been encountered, and each encountered “white” pixel will be “marked”. The motion of the detector stops when it is no longer able to move without hitting non-“white” pixels or pixels identified as previously encountered.

There are many ways of implementing the movement of the collision detector. A particular method is recursion. In some embodiments of the invention, to reduce overhead cost of the recursion method and to prevent possible stack overflow in the processor during implementation, a “breadth-first search” technique with a queue data-structure is used in the same way as in the flooding process described above.

In a particular embodiment of the invention, for example to be used when processing a head-and-upper torso portrait image, moving the collision detector is repeated with the detector starting from 3 other locations, namely a “white” pixel somewhere on the top edge close to the top right corner (moving downwards), a “white” pixel somewhere on the left edge (moving rightwards), and a white pixel somewhere on the right edge (moving leftwards). The third and fourth starting positions should be such that they are in the background, (e.g. above the shoulder for the person in the portrait). Preferably, during each repetition, the detector does not traverse pixels that have been visited previously and can be so determined by the appropriate identification mentioned above. It is to be understood that the repetitions of moving the detector are application specific and the number of repetitions and the starting position of the collision detector are selected as desired. Normally, one or two repetitions may be sufficient; the last few repetitions may not even start if all of the edges have been encountered by earlier repetitions.

A problem known to occur with this method is, if the top of the silhouette object is very close to the top edge of the picture and the width of the gap between the silhouette object and the top edge of the picture is less than the radius of the collision detector, the detector cannot advance past the top of the silhouette object. This problem is easily solved by creating a “buffer” area above the silhouette object for the disc to pass through.

After the collision detector has completed the repetitions of movement outside of the object, the interior of the object should be left “unmarked”. It may be advantageous to halve the grey levels of the “unmarked” pixels in the IGA picture, so as to distinguish them clearly from the “marked” ones.

### Process Pixels in IGA Picture

Step 140 of moving the collision detector outside the object is used to identify the interior of the silhouette object (or more correctly, to identify those places that are not in the interior). However, as a result the interior of the object is often defined to be slightly larger than the silhouette of the actual object due to the nature of the movement of the detector. The result can be improved by performing some additional processing, step 150, on the image output from step 140. For example, applying a dilation operation twice on the picture produces good results. More generally, one or more than one dilation operation may be applied. Dilation is a morphology operation in which the grey level of each pixel is replaced by the maximum grey level of the 9 pixels around it. The dilation operation causes a slight shrinkage of the object. While dilation is one specifically described operation performed at step 150, using other image processing techniques is considered to be within the scope of the invention. One such example of other image processing techniques is combining dilations with morphological opening or closing. Opening is erosion followed by dilation, and closing is dilation followed by erosion, where erosion is an operation that replaces the grey level of each pixel by the minimum grey level of the 9 pixels around it.

### Process Pixels Within Silhouette Object

Step 160 further aids in defining the silhouette of the object by analyzing the area within the coarse boundary established in step 140. Step 160 involves moving another collision detector within the interior of the silhouette object. The detector may be of a similar type to the disc shaped detector described above or it may have different parameters such as size or shape.

The following is an example of how the disc shaped collision detector is used to process the area within the silhouette object. The detector is initially located at a position where it is believed that the object is located. For example, in the case of the head-and-upper torso portrait, the silhouette object is generally centered in the image with the upper body filling most of the bottom edge of the image. Therefore, the detector is located at a midpoint between the side edges of the image near the bottom edge. The detector is allowed to move freely over “non-white” pixels within the currently identified boundaries of the silhouette object. Whenever an edge of the detector encounters a “white” pixel, (which should be just outside the silhouette object by virtue of markers set in step 140), the detector cannot proceed further, and the encountered pixel will be labelled as a boundary pixel of the silhouette.

In this way, the silhouette of the silhouette object is obtained by collecting all of the labelled boundary pixels.

The radius of the disc shaped region should not be set too small or it may escape into the area outside the silhouette object of the image. Similarly it should not be set too large else details in the curvature of the silhouette may be lost.

In some embodiments of the invention, as with processing outside the silhouette object at step 140, breadth-first search with a queue data-structure is used instead of recursion to implement the inside the silhouette object processing.

In a particular embodiment of the invention the silhouette image is output with a set of silhouette boundary pixels identifying the silhouette, where distances between adjacent boundary pixels are no less than some user-specified value d. To produce such an output, whenever the collision detector contacts a white pixel: a circle of radius d is drawn about the white pixel and every white pixel inside the circle (excluding the white pixel itself) is converted into a black pixel. In this way, it is ensured that the next contacted pixel will be at distance d from the white pixel. If desired, these silhouette boundary pixels can then be arranged so that they run along the silhouette in order.

### Output Silhouette

The output at step 190 is an order set of silhouette boundary pixels, given by their row and column numbers. These pixels may be continuous or evenly spaced.

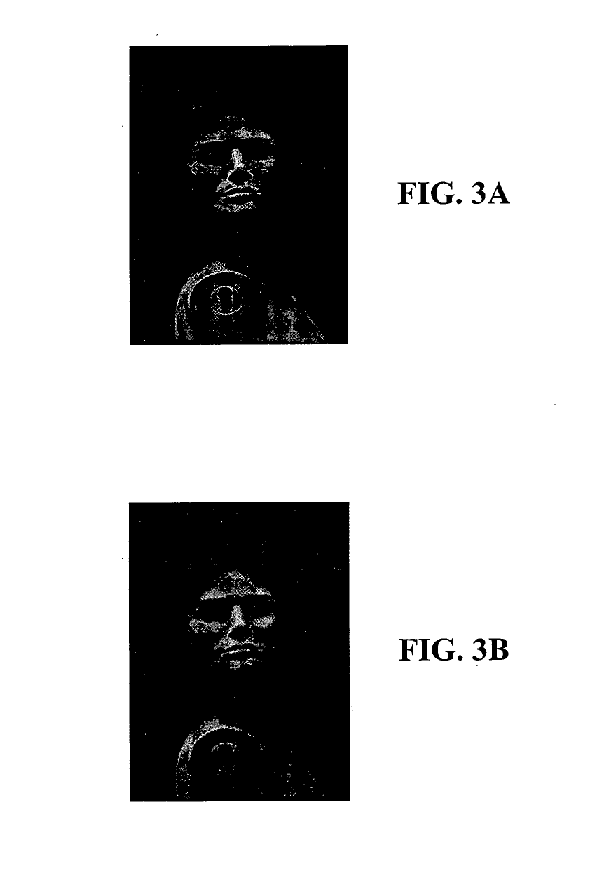

FIGS. 3 to 8 provide an example of an image processed using the method of FIG. 1.

FIG. 3A depicts an original picture of a mannequin with black hair to be operated on by the method of FIG. 1. A processed picture by an “Average” operation in step 120 is shown in FIG. 3B. A blurring effect can be observed along the silhouette, which produces the small IGA regions in step 130.

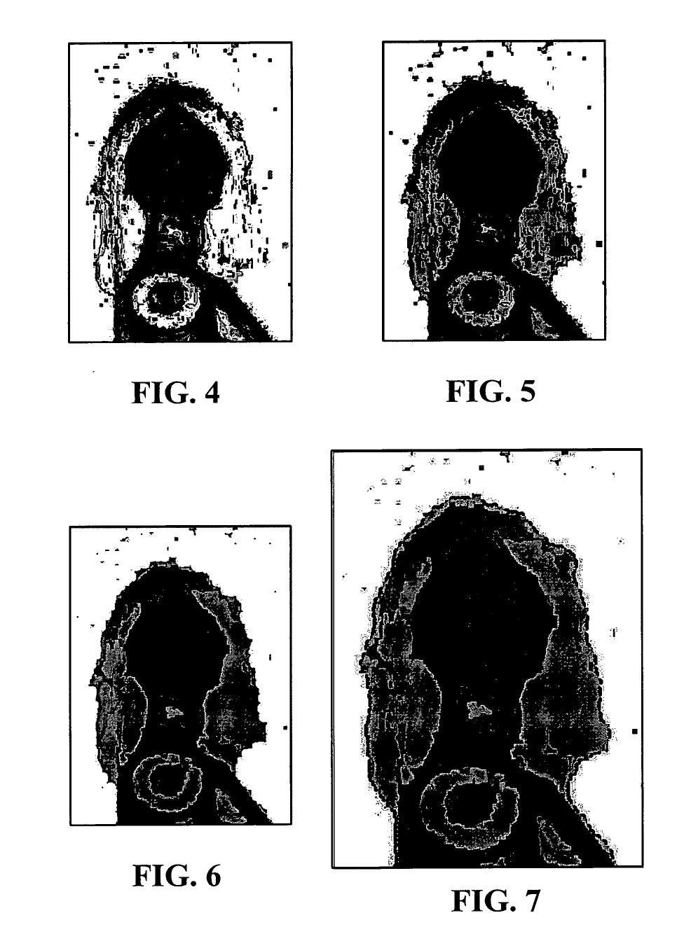

FIG. 4 shows the IGA picture Q representation for the image of FIG. 3A resulting from step 130. The IGA picture Q in FIG. 4 was generated using 100 as the area threshold. It can be seen that regions in the original input picture P that have varying grey levels, such as the face, become dark in the picture Q representation.

The IGA picture of the image of FIG. 3A following step 140 is shown in FIG. 5. The interior of the portrait are distinctively darker after halving the grey levels there.

FIG. 6 shows the effect of the pixel processing of step 150, specifically the dilation operation. We can see that this process not only affects the pixels of the silhouette object, but also the pixels in the background.

The dotted silhouette of the original image from FIG. 3A resulting from step 160 is shown in FIG. 7. A larger image than that of the original is used so that the dotted silhouette can be seen. The black patches along the boundary of the silhouette are produced by “painting” the circles around each contacted pixel black, as described above.

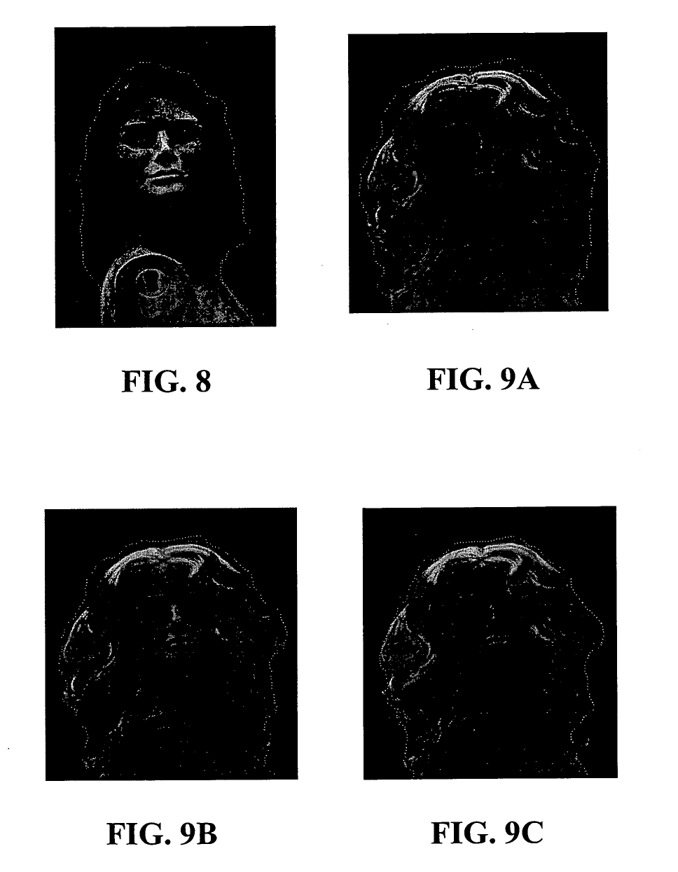

FIG. 8 is a visualization of the output at step 190. It is formed from the original FIG. 3A by turning the silhouette boundary pixels white.

### Process Given Picture Further

In the above example, the method successfully generated the silhouette of the black-haired mannequin against a black background. If a person has fine hair that sticks out from their head, the method will produce a silhouette enclosing the fine pieces of hair.

If the user wants to tighter the silhouette around the hairline, further processing can be performed on the image, as indicated in FIG. 1 by decision step 170 and the yes path leading to step 180. In addition to the original types of processing performed at step 120 such as “Average” operations on the given picture, further operations can also be performed. In some embodiments multiple iterations of the refining step are performed. A preferred additional operation for a first tightening is “Median-then-Average”, and for a subsequent tightening a preferred operation is “Bias-then-Median-then-Average”. A “Bias” operation is a morphology operation in which for each pixel p, a pixel q is found in its 3×3 neighbourhood with a grey level c closest to some biased value b, and the grey level c is assigned to p. So, if there exists a pixel in the neighbourhood with grey level less than or equal to b and there exists a pixel in the neighbourhood with grey level greater than or equal to b, then p will be assigned the grey level b. In some embodiments of the invention, for example to be used when processing the head-and-upper torso portrait, the average grey level that is used around the upper left and right corners as b.

FIG. 9A is a visualization, in a similar fashion to FIG. 8, of the output for a different input image. In this case the input image can be seen to be a mannequin with blonde hair that has a significant amount of portions of the hair that spread out in many different directions. In FIG. 9A it is seen that the silhouette boundary pixels do not conform closely to the silhouette of the hair of the mannequin. FIG. 9B shows another visualization of the original image with a silhouette boundary that has been processed by repeating the method to tighten the silhouette boundary. FIG. 9C shows a further visualization of the original image where the silhouette boundary has been processed by repeating the method another time to tighten the silhouette boundary.

The method of FIG. 1 works well in most cases. However, even though the method does not depend on the number of pixels in the picture or the number of grey levels, it may not work well for pictures with very low resolution and very small grey level granularity. A particular example in which the described method is effective is for pictures with 1024*768 pixels and 256 grey levels. Also, as mentioned above, the method is not well suited for backgrounds that are far from being plain, with texture or shadows.

Other factors that can affect the method are narrow and sporadic protrubances from the main object for which the silhouette is desired. For example, if a person has flamboyant hair with thin portions of hair directed away from the head, or if the person wears a long ornament like earrings.

Furthermore, an exact representation of the silhouette may not be possible if some part of the person's hair, skin or clothing on the boundary between the silhouette and the background has a constant grey level that is exactly identical to the background. In the case of hair in particular, this is improbable because hair is made of many individual hair strands which usually differ by at least one grey level.

Since the above-described factors are unlikely or can be avoided easily, the method is robust in most situations.

The speed of the proposed method is comparable to the existing methods, as they roughly have the same degree of complexity.

### Applications of the Algorithm

The method as described with respect to FIG. 1 was further illustrated by an example of an image of the head-and-upper torso of a person, or in actual fact a mannequin. A particular application of the method is for use in inside-engraving of crystals based on a portrait of a person, where finding the silhouette of the person is a first and essential step in the overall process.

A potential use of the method is to replace blue (or green) screens in the movie industry. Blue screening is presently the standard method for producing special effects: an actor acts in front of a blue screen, and all the blue colour within some brightness range is replaced by a different background. Some limitations of the bluescreen technique are that the captured images are typically filmed in a studio with a specially painted blue wall and floor; it requires careful lighting setup; there should be no similar blue colour on the actor's wardrobe; and there are problems with shadows and “blue spills” onto the actor creating a blue tinge around the edges. Embodiments of the invention do not have similar problems. The shooting can be done in a studio with ordinary walls or in an outdoor environment.

Embodiments of the invention can also be used in surveillance and security systems, where a silhouette helps in singling out a person or a face for facial recognition.

For stereoscopic imaging of a person, the silhouettes obtained for the left and right images can be used to generate the position of the person using stereo disparity techniques on the silhouettes.

Numerous modifications and variations of the present invention are possible in light of the above teachings. It is therefore to be understood that within the scope of the appended claims, the invention may be practised otherwise than as specifically described herein.

1. A method of extracting a silhouette of an object against a fairly plain background in an image comprising a plurality of pixels, the method comprising:
processing the image by determining if adjacent pixels of the image have an equal grey level value, the processing being independent of the numerical values of the original grey level values of pixels of the image.

2. The method of claim 1 wherein the processing comprises:
forming iso-grey regions by partitioning regions of pixels in the image that are adjacently connected and have the same grey level value; and
modifying the grey level value of each iso-grey region to be equal to a new grey level value.

3. The method of claim 2 wherein modifying the grey level of each iso-grey region to be equal to a new grey level value comprises setting the grey level value of the pixels in each respective iso-grey region equal to a number of pixels in the respective iso-grey region.

4. The method of claim 3 wherein iso-grey regions that have a number of pixels less than a selectable threshold value are modified by being assigned another new grey level value that aids in determining a coarse boundary of the object.

5. The method of claim 3 wherein for each respective iso-grey region, if the new grey level value is greater than a given threshold value the grey level value of all pixels in the respective iso-grey region is set to a grey level value equal to a largest grey level that is greater than the threshold value and if the new grey level value is less than a given threshold value the grey level value of all pixels in the respective iso-grey region is set to a grey level value within a selected subrange of the full range of grey level values that is proportional to the actual grey level value within the full range of grey levels, the grey level value within a selected subrange aiding in determining a coarse boundary of the object.

6. The method of claim 2 wherein processing the image further comprises:
defining a coarse boundary around the object by analyzing the area outside the object and marking the coarse boundary;
defining the silhouette of the object by analyzing the area within the coarse boundary around the object.

7. The method of claim 6 wherein analyzing the area outside the object comprises moving a detector around the image in an area external to the object and identifying pixels that define the coarse boundary of the object; and
wherein analyzing the area inside the object comprises moving a detector around the image in an area internal to the object and identifying pixels that define the silhouette of the object.

8. (canceled)

9. The method of claim 7 wherein the detector comprises a circular shaped region having a radius of one or more pixels.

10. The method of claim 1 wherein prior to the step of determining if adjacent pixels of the image have an equal grey level value, a further step comprises operating on each pixel of the plurality of pixels in the image to modify the grey level value of each pixel with the purpose of creating iso-grey regions in close proximity to the object that aid in determining a coarse boundary of the object.

11. The method of claim 10 wherein operating on each pixel of the plurality of pixels comprises one of a group of mathematical operations consisting of:
1) calculating an average grey level value of a given pixel and the grey level values of pixels adjacent to the given pixel and applying the calculated average to the given pixel for each of the plurality of pixels;
2) calculating a median grey level value of a given pixel and the grey level values of pixels adjacent to the given pixel and modifying the grey level value of the given pixel by applying the calculated median grey level value to the given pixel for each of the plurality of pixels followed by calculating an average grey level value of the modified grey level value of the given pixel and the modified grey level values of pixels adjacent to the given pixel and further modifying the grey level value of the given pixel by applying the calculated average to the given pixel for each of the plurality of pixels; and
3) calculating an average grey level value of a given pixel and the grey level values of pixels adjacent to the given pixel and modifying the grey level value of the given pixel by applying the calculated average to the given pixel for each of the plurality of pixels, calculating a median grey level value of the modified grey level value of the given pixel and the modified pixels adjacent to the given pixel and further modifying the grey level value of the given pixel by applying the calculated median grey level value to the given pixel for each of the plurality of pixels and calculating the average grey level value again of the given pixel and the grey level values of pixels adjacent to a given pixel and yet again modifying the grey level value of the given pixel by applying the calculated average grey level value to the given pixel.

12. The method of claim 6 wherein subsequent to defining a coarse boundary, a further step comprises operating on each pixel of the plurality of pixels in the image to further define the coarse boundary.

13. The method of claim 12 wherein operating on each pixel of the plurality of pixels comprises modifying the grey level of each pixel by using one or more repetitions of a dilation operation, the dilation operation modifying the grey level of each pixel to be equal to a maximum grey level of the pixel and the pixels adjacent to the pixel.

14. The method of claim 6 wherein the steps of forming iso-grey regions, defining a coarse boundary and defining the silhouette are repeated to further refine the shape of the silhouette.

15. (canceled)

16. The method of claim 14 wherein the steps are repeated more than once.

17. The method of claim 16 wherein before a first repetition when the steps are repeated more than once, each pixel of the plurality of pixels in the image is operated on in a manner comprising:
calculating a median grey level value of a given pixel and the grey level values of pixels adjacent to the given pixel and modifying the grey level of the given pixel by applying the calculated median grey level to the given pixel for each of the plurality of pixels; and
calculating an average grey level value of the modified grey level value of the given pixel and the modified grey level values of pixels adjacent to the given pixel and further modifying the grey level value of the given pixel by applying the calculated average grey level to the given pixel for each of the plurality of pixels.

18. The method of claim 16, wherein before a repetition when the steps are repeated more than once, each pixel of the plurality of pixels in the image being operated on in a manner comprising:
calculating a bias grey level value of a given pixel and the grey level values of pixels adjacent to the given pixel and modifying the grey level value of the given pixel by applying the calculated bias to the given pixel for each of the plurality of pixels;
calculating a median grey level value of the given pixel and the grey level values of pixels adjacent to the given pixel and further modifying the grey level value of the given pixel by applying the calculated median grey level value to the given pixel for each of the plurality of pixels; and
calculating an average grey level value of the given pixel and the grey level values of pixels adjacent to the given pixel and yet again modifying the grey level value of the given pixel by applying the calculated average grey level value to the given pixel for each of the plurality of pixels.

19. The method of claim 1 wherein the object is a head and upper torso of a person.

20. A computer readable medium having computer readable program code means embodied therein for extracting a silhouette of an object against a fairly plain background from an image comprising a plurality of pixels, the computer readable code means comprising:
code means for processing the image, the processing comprising determining if adjacent pixels of the image have an equal grey level value, the processing being independent of the numerical values of the original grey level values of pixels of the image.

21. The computer readable medium of claim 20, the computer readable code means further comprising:
code means for forming iso-grey regions by partitioning regions of pixels in the image that are adjacently connected and have the same grey level value; and
code means for modifying the grey level value of each iso-grey region to be equal to a new grey level value.

22. The computer readable medium of claim 21, the computer readable code means further comprising:
wherein the code means for modifying the grey level of each iso-grey region to be equal to a new grey level value comprises code means for setting the grey level value of the pixels in each respective iso-grey region equal to a number of pixels in the respective iso-grey region.

23. The computer readable medium of claim 22, the computer readable code means further comprising:
code means for, if the new grey level value is greater than a selectable threshold value, setting the grey level value of all pixels in the respective iso-grey region to a grey level value equal to a largest grey level that is greater than the threshold value; and
code means for, if the new grey level value is less than a given threshold value, setting the grey level value of all pixels in the respective iso-grey region to a grey level value within a selected subrange of the full range of grey level values that is proportional to the actual grey level value within the full range of grey levels;
the grey level value within a selected subrange aiding in determining a coarse boundary of the object.

24. The computer readable medium of claim 21, the computer readable code means further comprising:
code means for defining a coarse boundary around the object by analyzing the area outside the object and marking the coarse boundary;
code means for defining the silhouette of the object by analyzing the area within the coarse boundary around the object.

25. The computer readable medium of claim 20, the computer readable code means further comprising:
code means for operating on each pixel of the plurality of pixels in the image to modify the grey level value of each pixel with the purpose of creating iso-grey regions in close proximity to the object that aid in determining a coarse boundary of the object.

26. (canceled)

27. The computer readable medium of claim 24, the computer readable code means further comprising:
code means for initiating repeating the steps performed by the code means for forming iso-grey regions, defining a coarse boundary and defining the silhouette to further refine the shape of the silhouette.

28. (canceled)
